(19) United States
(12) Patent Application Publication
(10) Pub. No.: US 2005/0220280 A1
(43) Pub. Date: Oct. 6, 2005

(54) System and method for rating alternative solutions

(76) Inventor: David A. Steinberg, Bethesda, MD (US)

Correspondence Address: Patton Boggs, LLP, Suite 3000, 2001 Ross Avenue, Dallas, TX, 75201, US

(21) Appl. No.: 10/975,721

(22) Filed: Oct. 28, 2004

Related U.S. Application Data
(60) Provisional application No. 60/516,035, filed on Oct. 31, 2003.

(51) Int. Cl. H04M 11/00; H04M 15/00

(52) U.S. Cl. 379/93.12; 379/90.01

(57) ABSTRACT

A method of rating alternative solutions includes receiving preference indicators associated with a user and receiving prior use data associated with the user. The method further includes comparing alternative telecommunication service plans to the preference indicators and the prior use data and rating at least one of the alternative telephone service plans in response to the comparison.

### CROSS REFERENCE TO RELATED APPLICATION

This application claims priority from co-pending U.S. Provisional Application Ser. No. 60/516,035 filed Oct. 31, 2003, the entire teachings of which are incorporated by reference.

### BACKGROUND OF THE INVENTION

1. Description of Related Art

The number of voice and data telecommunications providers has significantly expanded during the last several years. Business enterprises and individual consumers lack an effective tool to compare service plans offered by such providers in order to select the best plan for their specific needs.

2. Technical Field of the Invention

This invention relates in general to the field of telecommunications, and more particularly to a system and method for rating alternative telecommunication service plans.

### SUMMARY OF THE INVENTION

In accordance with the present invention, a system and method for rating alternative solutions is disclosed that offers many advantages to business enterprises and individual consumers in selecting a telecommunications service plans.

In one aspect of the present invention, a method of rating alternative solutions is disclosed. The method includes receiving preference indicators associated with a user and receiving prior use data associated with the user. The method further includes comparing alternative telephone service plans to the preference indicators and the prior use data and rating at least one of the alternative telephone service plans in response to the comparison.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is one embodiment of a system for rating alternative solutions according to the teachings of the present invention;

FIG. 2 is one embodiment of a computer used to implement various components of the system illustrated in FIG. 1;

FIG. 3 is an embodiment of a method for rating alternative telecommunications service plans as shown in FIG. 1 according to the teachings of the present invention;

FIG. 4 illustrates an additional embodiment of a method of rating alternative service plans and monitoring use of such service plans according to the teachings of the present invention; and

FIG. 5 illustrates an embodiment of a method of rating alternative data and voice communication service plans according to the principles of the invention.

### DETAILED DESCRIPTION OF A PREFERRED EMBODIMENT

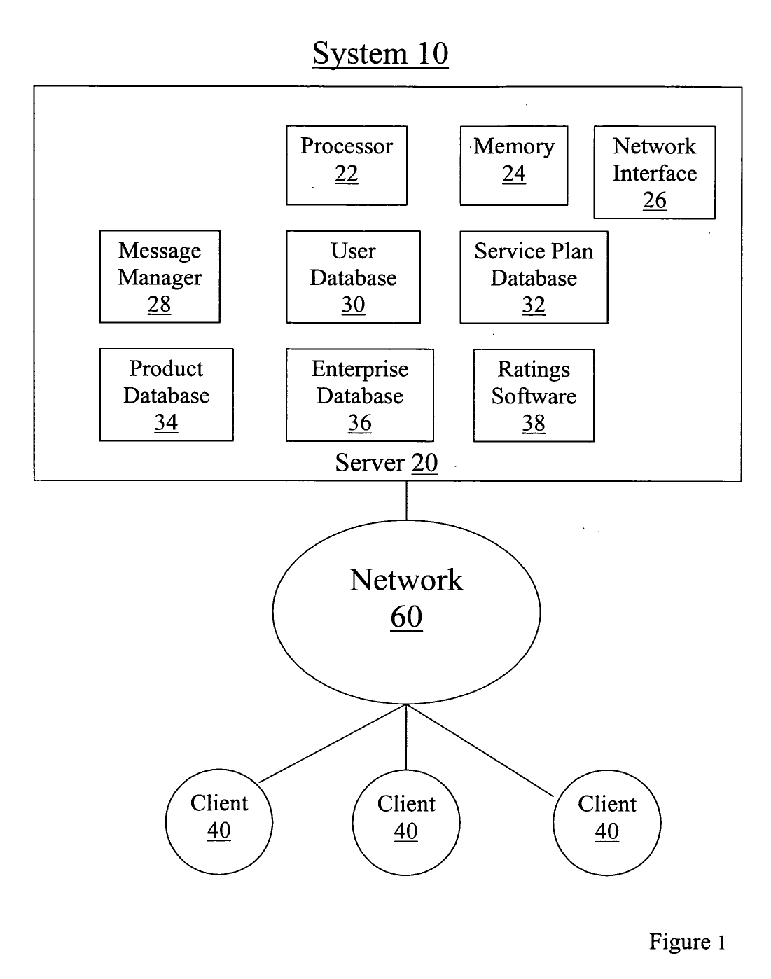

FIG. 1 illustrates a system 10 for rating alternative solutions according to the teachings of the present invention. More particularly, system 10 allows one or more users of telecommunications services, or someone making purchasing decisions on behalf of such users (each hereafter referred to as a user) to enter user information in order to select a product or service. In one embodiment of the present invention, a user with a current service plan such as a service plan for telecommunications services can “rerate” such existing plan against currently available service plans to determine if another plan is more suitable or cost effective. Although the following description of FIGS. 1-5 refers to comparing alternative service plans, one inventive embodiment of the present invention's use of the system and processes described herein is the ability to accomplish the rerating of an existing service plan based on newer alternative service plans to ensure that the existing service plan is or remains the best option for the user.

System 10 includes a server 20 in communication with one or more clients 40 over a network 60. Network 60 may be one or more private or public networks using dedicated or switched links. For example, in one embodiment server 20 may be one or more servers or computers that may communicate using a public or private network while server 20 and clients 40 may communicate using a public network such as the Internet, whether connecting directly to the Internet, or connecting indirectly via a wireless network such as a cellular network or a Public Switched Telephone Network (PSTN). Each of the communications links making up network 60 may be implemented using fiber, cable, twisted-pair, satellite, radio, microwave, laser or other suitable wired or wireless links.

Server 20 includes a processor 22, a memory 24, a network interface 26, a message manager 28, a user database 30, a service plan database 32, a product database 34, an enterprise database 36, and ratings software 38. Server 20 may be one or more specialized or general-purpose computing platforms having processing components, memory, and communication interfaces sufficient to interact with and communicate data over network 60. Certain components of server 20 are identified according to functional purpose and may all be executed using the same or different software routines stored in one or more memory components and executed using one or more processing components including but not limited to processor 22, memory 24, and network interface 26.

Server 20 provides a web-based interface to the contents of transaction server 20. Server 20 may store web pages, JAVA servlets, and other suitable content and executables to enable users of system 10 to easily access the features and capabilities of server 20. In one embodiment, server 20 is a voice-enabled server allowing users the capability of using voice commands to access the content of server 20.

Processor 22 may be any suitable combination of hardware and software, including without limitation, a microprocessor, microcontroller, ASIC, or software engine. Memory 24 may be any suitable combination of volatile or nonvolatile memory, addressed using any suitable addressing scheme, and present in one or more separate physical devices. Network interface 26 may be any suitable interface including without limitation a modem, network interface card, network gateway, or transceiver.

Message manager 28 is a messaging platform capable of using one or more methods to generate notifications and communicate information to and from users, enterprises, vendors, customer support departments, and system administrators. For example, in one embodiment message manager 28 may be a web page or JAVA servlet by which users of system 10 may view messages generated by another user or automatically by message manager 28 in response to a user selection. Alternatively, message manager 28 may be an automated email, instant messaging, wireless paging, voicemail, or other suitable messaging application generating messages to send to a user to notify such user of events.

User database 30 is a database of user profiles maintained by system 10. User database 30 stores user information such as a personal identity, contact or financial information about each user of system 10. User database 30 may also store preference indicators of a particular user as to particular preferences of the user with regard to a product or service plan. User database 30 may also store prior use data associated with user's prior use of products and services.

Service plan database 32 and product database 34 store parameters of services and products respectively. Such parameters may include the requirements, options, costs, and features of products, services, or the purchase programs or service plans under which such products and services may be ordered.

Enterprise database 36 stores information associated with a particular business entity. Such information may include information on employees of such entity, consultants of such entity, or users of particular products and services utilized by the entity in running a business. Enterprise database may also include statistical information regarding any user or all users in aggregate, purchasing information of the entity, costs incurred by the entity, and the particular products and services used by employees and consultants of the entity.

Rating software 38 is a software module using one or more of fuzzy logic, rules-based software, and iterative algorithms operable to compare user information such as preference indicators and prior use data to parameters and features of a particular product or service. Rating software 38 may be stored in memory 24 and executed by processor 22 or stored and executed using other suitable resources.

In one embodiment, each of clients 40 is a personal computer; alternatively, clients 40 may each be a client, workstation, terminal, personal computer, web appliance, personal digital assistant, cellular telephone, pager or any other suitable computing device having input and output modules that enable a user to enter and view data. Clients 40 may each include a web browser or other interface software and/or hardware, volatile or non-volatile memory, processor and/or other processing components, and/or other software, hardware, and peripherals suitable for such computing devices.

Although server 20 and clients 40 are referred to in the nomenclature of a client/server environment, a single computing device or a peer-to-peer environment or any other suitable arrangement of computing devices may be utilized to practice the present invention.

In system 10, HyperText Transfer Protocol (HTTP) is used to communicate information between server 20 and clients 40. Alternatively, File-Transfer Protocol (FTP), Telnet, Usenet, mobile agents, cookies, paging, electronic mail, instant messaging, bulletin boards, or any other suitable protocol or communication techniques may be utilized. Clients 40 may maintain and execute browsers or other suitable parsing programs for accessing and communicating information addressed by Uniform Resource Locators (URLs). Any suitable communications protocol may be implemented in combination with one or more generally available security and/or encryption techniques to ensure the secure, private communication of data between server 20 and clients 40.

In the illustrated embodiment, components of system 10 may be implemented in a programming environment that supports access or linking to various sources of information in system 10 using URL addresses. As such, the content of such modules and databases may be constructed using Hypertext Mark-Up Language (HTML), Extensible Mark-Up Language (XML), other forms of Standard Generalized Mark-Up Language (SGML), Virtual Reality Mark-Up Language (VRML), Javascript, or any other appropriate content development language. The modules of system 10 may also include program code, such as applets or servlets written in JAVA, or other appropriate self-executing code.

Although the components of transaction server 20 are illustrated in this FIG. 1 as separate databases, modules, subsystems and other illustrated components, each of such separate components may be implemented using a single processor for transaction server 20 such that the single processor accesses stored algorithms, executables, and other data that are stored in read-only memory, for example, and executed using random access memory. Likewise, such separate databases, modules, subsystems and other illustrated components may be combined, separated or distributed across one or more processing and/or memory devices. Memory for such databases, modules, subsystems, or other illustrated components of transaction server 20 may be implemented using one or more files, data structures, lists, or other arrangements of information stored in one or more components of random access memory, read-only memory, magnetic computer disks, compact disks, memory sticks, media cards, other magnetic, electronic, or optical storage media, or any other volatile or non-volatile memory.

Likewise, it should be understood that any components of system 10 may be internal or external to the illustrated components of system 10, depending on the particular implementation. Also, such databases, modules, subsystems or other components may be separate or integral to other components. Any appropriate referencing, indexing, or addressing information can be used to relate back to an address or location of a database, file or object within system 10.

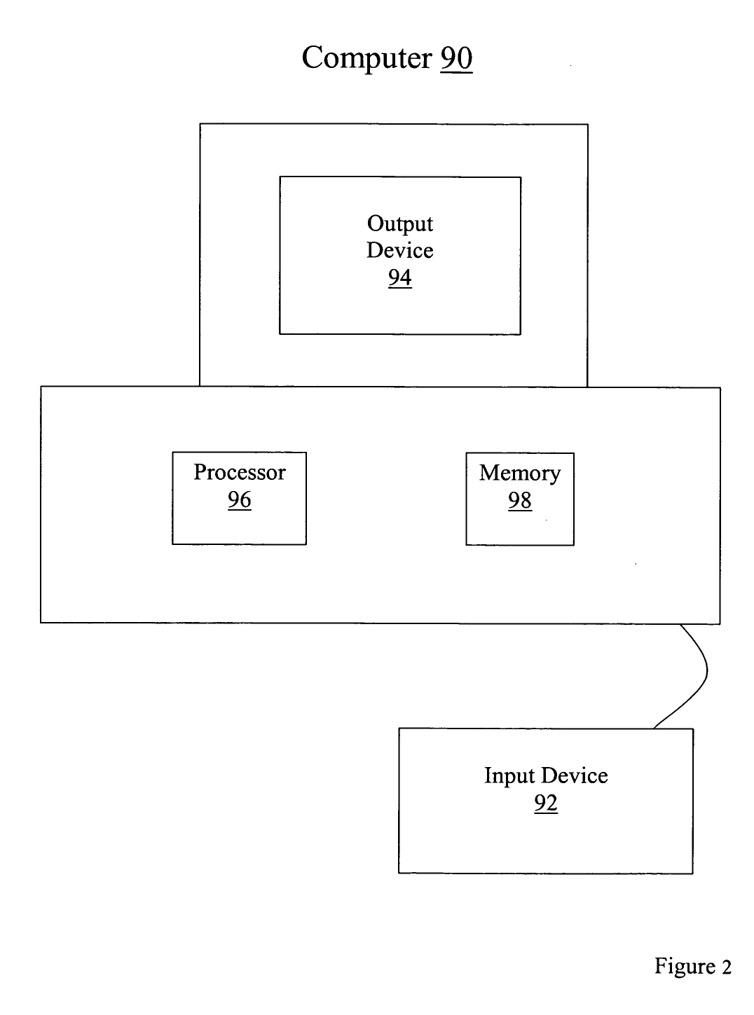

Referring to FIG. 2, server 20 and clients 40 may operate on one or more computers 90. Each computer 90 includes one or more input devices 92 such as a keypad, touch screen, mouse, microphone, or other suitable pointer or device that can accept information. An output device 94, such as a speaker, monitor or other display, for example, conveys information associated with the operation of server 20, or clients 40, including digital data, visual information, and/or audio information. A processor 96 and its associated memory 98 execute instructions and manipulate information in accordance with the operation of system 10. For example, processor 96 may execute coded instructions that are stored in memory 98. Computer 90 may also include fixed or movable storage media such as a magnetic computer disk, CD-ROM, or other suitable media to either receive output from, or provide output to, server 20 and clients 40.

In operation, system 10 allows a user or enterprise to outline the preferences and requirements for and otherwise rate, compare, select, purchase, and evaluate products and software such as telecommunications devices and service plans in order to select the device or plan most suitable.

The rating of system 10 may be accomplished by collecting user information such as personal data, the preferences of a user in the form of indications of preference (“preference indicators”), and prior use data and comparing and scoring such alternative solutions using such preference indicators and prior use data. Such rating system and process allows a user to select a particular product, service, or service plan based on prior use data including such user's current or past usage patterns with similar products, services, or service plans. Such rating system and process may recommend that the user stop using a current product, service, or service plan in favor or a cheaper or higher quality alternative, or may alternatively recommend that such current product, service, or service plan be retained. The rating system and process can be used to select among devices, services, or service plans offered by a single provider, among the entire available universe of providers, or any other selection pool of providers.

In operation, such rating system and process includes a user entering user information which is then used to compare the features and other parameters of available products, services, and service plans. User information may include descriptive information concerning the user. For example, in rating a wireless device, wireless service, or service plan, such descriptive information may include personal data such as: identification information, registration information, password information, home and business address information, travel or commute information, or any other information concerning the user relevant to the purchasing or selection of a wireless device product, service, or service plan.

User information may further include prior use data regarding the user's history of use of similar products, services, or service plans. For example, in rating a wireless service or service plan, such prior use data may include: total minutes or average minutes used during a particular time interval, minutes used during certain times of day, minutes used during days of the week, physical locations where calls participated in were originated and received, number of minutes during calls originated, number of minutes during calls received, number of directory of assistance calls, number of minutes used for web access, number of emails sent and received, number of text messages sent and received, number of pages sent and received, number of voicemails received, number of dropped calls, number of customer service calls, number of wireless devices under a wireless plan, allocation of minutes used between such devices, details on voice and dialing features, service plan contract length, or type of existing wireless device.

User information may also include the user's preference indicators. For example, in rating a wireless service or service plan, such preference indicators may include allocated budget information including a cap on monthly service fees, desired coverage areas, desired network providers, desired phone manufacturers, desired contract length, whether a purchase of a new wireless device is desired, a specific indication of mandatory service requirements and desired optional service features, or any other desired product, service or service plan feature or parameter. Additionally, such preference indicators may include prioritization factors. Such prioritization factors may include a user utilizing a preference indicator that indicates a preference between service features, service costs, the coverage area, the quality of the delivered service, the quality of customer and/or technical support related to the delivered service allocation, or any other criteria including the user preference information described above or other factors related to the decision. A preference indicator may include a prioritization factor that may be a selection, ranking, weighting factor, percentage of importance to a decision, assignation of categories such as required, important, unimportant, range of acceptability for a particular factor, cap, floor, or any other factor useful in rating.

User information may be entered via a paper form, web page, telephone interface, or any other suitable input device or method. In one embodiment, user information can be received electronically from a third party such as a service provider via an electronic bill, record, account summary, plan description, or other source and translated or mapped into a rating form or rating fields used to perform the rating process. For example, an XML interface could be used to reformat data into a format acceptable for rating.

Once all applicable user information has been received, the information is analyzed and used to compare user information to features and characteristics of different available products, services, or service plans (hereafter “alternatives”) to achieve one or more rankings of such alternatives. Such comparison can be performed using fuzzy logic, a rules-based software engine, or an iterative algorithm. Following or during such comparison a software algorithm scores such alternatives and/or a user's current product, service, or service plan. Such comparison and scoring may take into account the preference indicators determined by the user or default preference indicators stored by the rating system. After such comparison and scoring, one or more ranked lists or comparisons may be presented to a user. Such ranked lists or comparisons may be presented to a user in an order of importance determined using the above-described preference indicators, or in alternative orders of importance based on a listing factor selected by the user (cost, number of included minutes, quality of service delivered rating, customer service rating, etc.).

One embodiment of a rating process used to select a service plan includes receiving user information including user preferences and preference indicators. Some preference indicators may be designated as mandatory requirements by a user or enterprise. First, alternatives are compared to preference indicators to remove service plans that do not meet mandatory requirements. For example, service plans that: have a mandatory service contract length, require the purchase of a new phone, or do not have coverage area for a specific geography may be eliminated. Second, alternatives are compared to preference indicators to select service plans that best satisfy the one or more user preferences ranked as most important, having the highest weighting factor, percentage of importance, etc. Such alternatives may be assigned a preliminary score or ranking at any time during comparison to preference indicators. Next, user preferences assigned a lower weight or ranking via a preference indicator are compared and the preliminary ranking may be adjusted in response to such comparison. For example, a service plan scoring 100% or ranked first based on the most important user preferences may have its scored reduced according to a weighting factor of the next most important user preference if such service plan does not fully satisfy such next most important user preference. The rating process may be repeated in an iterative fashion or according to rules maintained by the rating system. For example, a default rule may be used that a user never be presented with a service plan having more than 200% of the minutes used by his current plan unless it costs less than such user's current plan.

Service plans may also be compared to other user information to determine if a plan is otherwise appropriate for a particular user. For example, prior use data can be combined with preference indicators to prepare a suitably robust model for comparison to available service plans. Prior use data may otherwise exclude a particular plan based on excessive cost if prior use continues as previously conducted. Prior use data may also enable reduced rates on service plans offered by service providers to attract heavy users of wireless devices, a particular market segment, or enterprises with a history of high use spread across a pool of users. Once all of the available data is analyzed and a final ranking, scoring, comparison results, or other subjective rating is determined, the information is presented to a user in a suitable form to enable a final selection of a service plan by a user. For example, the overall best match, the top five scorers, the cheapest service meeting mandatory requirements, or the highest quality service meeting mandatory requirements, or a combination of any of the foregoing, may be presented to the user.

The rating process may be integrated with a purchasing system and process to enable a user to complete an end-to-end process resulting in the purchase and activation of a finally selected service plan for the user. In one embodiment, purchase information, a purchase contract, or an application for service is automatically populated from the user information used to perform the rating process. The rating system may be implemented using any server/client arrangement and may include a processor, memory, and user interface to execute the rating process. For example, the rating service may be offered on a web server to users accessing a website on the Internet.

The rating process can store historical data regarding user information and prior use data. By analyzing usage patterns in such historical data over time, better recommendations can be made and more accurate scoring and/or ranking of alternative service plans can be accomplished. For example, a single monthly bill may be an unrepresentative view of usage patterns. If data is collected over the course of a longer period such as a full year, the rating process may better account for spikes in usage during particular months (December for example) versus more typical usage during other months.

The rating process also allows several users' information and prior usage data to be grouped and even sub-grouped. This allows for analysis, scoring and recommendations based on family, company, or group. Looking at the full set of data for the entire group may lead to different recommendations or scoring of service providers then an analysis of individual users within such group. In such a manner, organizations can aggregate users for purposes of analyzing costs and other benefits of alternative service plans, services, or providers.

In the rating process, hypothetical data can be applied to historical data to allow users to see the cumulative affect of a decision based on choices they are considering. For example, a user may want to see how much they would have spent during the prior year if they had chosen a different rate plan. The user could also see how much the selection of a particular plan feature would increase or decrease their cost. Additional modeling can be presented to user based on any combination of historical data, hypothetical data, available service plan parameters, and budgeting constraints.

The results of a rating process can be integrated within a customer service model of a particular service provider. More specifically, risk factors affecting spikes in cost can be assessed based on prior user data or other historical data. For example, if a service plan was selected with a significant cost component associated with minutes of use in excess of a base minute limit, reminders could be sent to a user nearing such base minute limit through text or voice messages to an associated wireless device, email address, or any other suitable notifications mechanism. Reminders can also be based on any usage trends or statistics or any service plan parameter. For further example, if a user's trends indicate certain spikes in usage during particular times, further messages can be sent to the user based on this data. Usage data may be analyzed continuously during the term of use of a service and in response to such analysis a user may be notified of: (i) usage spikes or trends that would indicate that the user is trending to use that is outside their normal usage bounds and/or budgeted amount; or (ii) an alternative service plan available that would decrease their overall cost.

The rating process can be used for a particular device or service such as voice services or data services. Alternatively, the rating process may rate or recommend products, services, or service plans using a combined metric of voice service information and data service information. In such a manner, comparisons can be made that may recommend using a single product, service, service plan, or provider for both voice and data, or a first option for voice services and a second option for data services. In such a manner, the metrics of multiple services can also be optimized for the best selection of overall cost, quality of service, and available features.

The ranking, scoring, or comparison of products, services, or service plans may also be configured to take into account preferred or featured providers or their products, services, or services. For example, ranking, scoring, or comparison results can be configured to only present to a user, or present to a user at the top of an ordered overall list or in an otherwise highlighted fashion, providers that: achieve a specific best buy or recommended rating or other designation; receive an award from an industry organization, consumer protection organization, or other entity for quality, customer service, or any other desirable attribute; or maintain a preferred relationship with the entity performing the rating such as a marketing relationship or referral arrangement.

Additionally, the rating tool can be integrated with resource management systems to enable businesses and enterprises collect information regarding user information and cost information for a relevant pool of employees and/or contractors and optimize resources and minimize costs within such business or enterprise. In such a manner, the rating tool could be utilized as an employee tracking tool to monitor employee use of particular products and services and/or the cost of doing so. The rating tool could be further integrated with business accounting/expense management systems to allow cost modeling and enable the direct routing of purchasing requests from individual employees for approval to appropriate management resources.

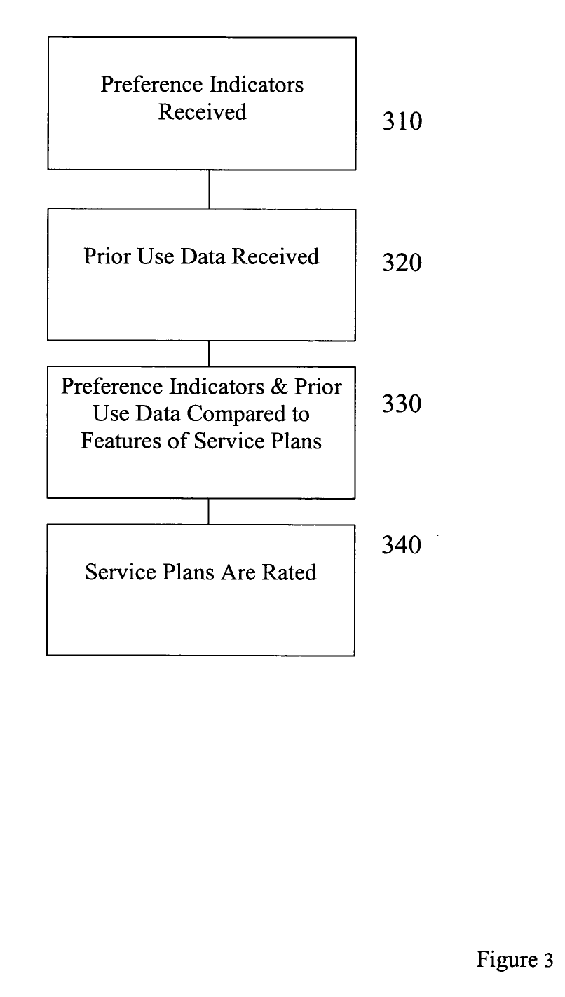

Now referring to FIG. 3, one embodiment of a method for rating alternative telecommunications service plans is disclosed according to the teachings of the present invention. The method may be practiced using the components of FIGS. 1 and 2 or any other suitable systems, devices, networks, and other components. In step 310, preference indicators associated with a user are received. In step 320, prior use data associated with the user is received. In step 330, alternative telecommunications service plans and their features and other parameters are compared to the preference indicators in the prior use data. In step 340, the alternative telecommunications service plans are rated in response to the comparison.

In step 310, the preference indicators that are rerceived may designate mandatory requirements of a user or enterprise for any telecommunication service plans. Thus, in step 330, comparing the alternative telecommunication service plans to the preference indicators may include determining which of the alternative telecommunication service plans meet the mandatory requirements.

In step 310, receiving preference indicators may include receiving preference indicators associated with a family, group, organization, or other combination of users such as an enterprise or business entity. Step 320 may also include additional prior use data associated with such additional users. Thus, the comparison of alternative telecommunication service plans to preference indicators and prior use data may be done for a group of users and the rating accomplished in step 340 may therefore rate alternative telecommunication service plans after considering preference indicators and prior use data across a group of users.

Step 330 may be accomplished using fuzzy logic software, rules-based software, or iterative algorithms. Step 330 may include first comparing alternative telecommunication service plans to mandatory requirements of a user, group of users, or enterprise and eliminating alternative telecommunication service plans that do not meet such mandatory requirements. A comparison may then be done of preferred or desirable features that a user may request to the features or other parameters of the alternative telecommunications service plans that meet those mandatory requirements.

The rating accomplished in step 340 may include assigning a score to one or more of the alternative telecommunication service plans. Rating may also include ranking of telecommunication service plans based on the results of the comparison. Rating may also include assigning a rating such as a “best match” designation, recommended designation, or other text or graphical designation indicating a relative rating of the alternative telecommunication service plans. Rating may also include presenting a graphical or textual side-by-side tabulation of features or other parameters of the alternative telecommunication service plans that can be presented to a user or stored for later access. Rating may be further conducted based on the cost, number of minutes, quality of service, or any other parameters set by a user, a vendor of the telecommunication service plans, or an entity responsible for the rating process. Rating may also be accomplished in response to a recommendation or award by an industry, organization, vendor, or other entity or group. Rating may further be accomplished in response to a preferred relationship such as a preferred vendor relationship associated with any of the vendors of the alternative telecommunication service plans.

The preference indicators received in step 310 may already be ranked, weighted, or otherwise prioritized by a user.

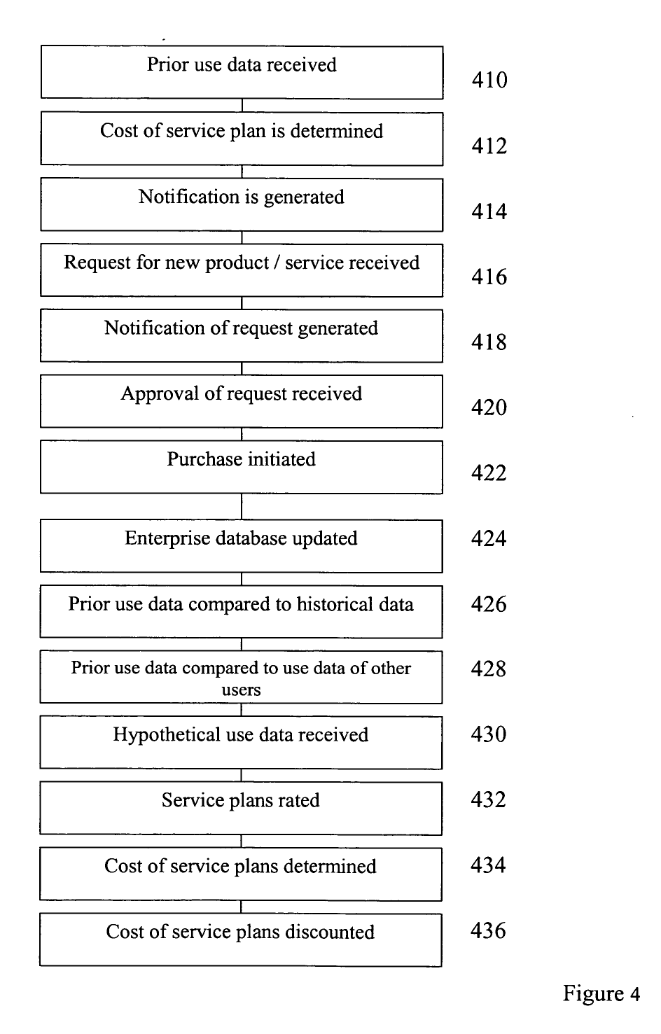

Referring to FIG. 4, a method of rating alternative service plans and monitoring use of such plans is disclosed. At step 410, prior use data associated with a user is received. Such prior use data may include use data of a user during a current month or other term of a service plan. In step 412, a cost associated with the user for the service plan is determined in response to receiving the prior use data. In step 414, a notification is generated if the determined cost exceeds a predetermined threshold. In step 416, a request for a new product or service associated with the user is received. In step 418, a notification is generated in response to receiving the request. In step 420, an approval is received in response to the generated notification. In step 422, a purchase is initiated in response to the received approval. In such a manner, upon receipt of an approval a purchase can be initiated, a transaction conducted, and the delivery of a product or service fulfilled automatically by a system such as system 10. In step 424, a database of an enterprise is updated in response to receiving the prior use data. In step 426, the prior use data is compared to historical data stored in the database. In such a manner, the prior use data can be analyzed relative to the historical data. In step 428, the prior use data of the user is compared to additional use data of other users.

The prior use data received in step 410 may include the number of minutes used of a service during the present month. In such event, determining the cost in step 412 can include comparing the received number of minutes to a threshold. The notification generated in step 418 may include a notification that the number of units available in a current service plan have been exceeded or a notification that an alternative service plan is available that would reduce the cost of a service.

A rating of a service plan may include determining the cost of the service plan during at least one historical billing period in response to the received prior use data.

In step 430, hypothetical use data associated with a user is received. In step 432, the hypothetical use data is used to rate at least one of the alternative telephone service plans by determining the cost of the plan during at least one future billing internal using the hypothetical use data. In step 434, rating at least one of the alternative telecommunication service plans may be accomplished by determining the cost of the at least one of the alternative telecommunication service plans during at least one future billing period using hypothetical use data derived from the prior use data. In step 436, the cost of at least one of the alternative service plans is discounted in response to the prior use data received in step 410. Such costs may be discounted, for example, in response to comparing the prior use data to at least one threshold or in response to the number of individual users associated with the user for which the prior use data was received. For example, a user who is part of a larger business entity or is seeking subscription to a service plan as part of a family, larger organization, or other pool of users may receive a discount.

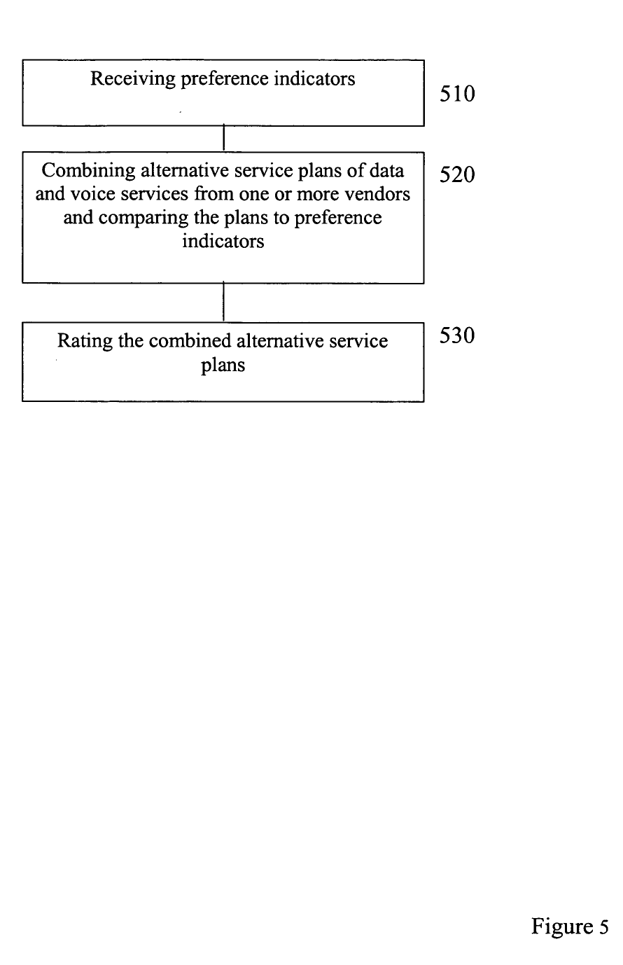

Now referring to FIG. 5, a method of rating alternative data and voice communication service plans is disclosed. At step 510, preference indicators associated with one or more users are received. At step 520, the alternative service plans are compared to the preference indicators of the users. In step 530, the service plans are rated in response to the comparison. The comparison accomplished in step 520 may include comparing a first combination of a data communication service plan and a voice communication service plan offered by the same vendor to a second combination of a data communication service plan and a voice communication service plan offered by two different vendors. Step 520 may also include comparing preference indicators that are associated with a communications device to the features of communications devices available or otherwise compatible with the service plans.

Although particular embodiments of the present invention have been explained in detail, it should be understood that various changes, substitutions, and alterations can be made to such embodiments without departing from the spirit and scope of the present invention as defined solely by the following claims. In particular, although the majority of the embodiments described herein are described in terms of the rating of service plans, such rating embodiments can be used to rate any product, service, or solution.

1. A method of rating alternative telecommunication service plans, the method comprising:
receiving preference indicators associated with a user;
receiving prior use data associated with the user;
comparing the alternative telecommunication service plans to the preference indicators and the prior use data; and
rating at least one of the alternative telecommunication service plans in response to the comparison.

2. The method of claim 1, and further comprising:
determining mandatory requirements in response to receiving the preference indicators; and
further determining which of the alternative telecommunication service plans meet the mandatory requirements.

3. The method of claim 1, and further comprising:
receiving additional preference indicators associated with additional users associated with the user;
receiving additional prior use data associated with the additional users; and
wherein rating the at least one of the alternative telecommunication service plans further comprises rating the at least one of the alternative service plans in response to an additional comparison done using the additional preference indicators and the additional prior use data.

4. A method of rating alternative telecommunication service plans, the method comprising:
receiving mandatory requirements associated with a user;
receiving additional user information associated with a user;
comparing the alternative telecommunication service plans to the mandatory requirements;
selecting at least one of the alternative telecommunication service plans in response to the comparison;
additionally comparing the selected at least one of the alternative telecommunication service plans to the additional user information; and
rating at least one of the selected at least one alternative telecommunication service plans in response to the additional comparison.

5. A method of rating alternative telecommunication service plans using a computer, the method comprising:
receiving preference indicators associated with one or more users;
comparing the alternative telecommunication service plans to the preference indicators; and
rating at least one of the alternative telecommunication service plans in response to the comparison.

6. The method of claim 5, wherein rating at least one of the alternative telecommunication service plans includes assigning a score.

7. The method of claim 5, wherein rating at least one of the alternative telecommunication service plans includes assigning a rank.

8. The method of claim 5, wherein rating at least one of the alternative telecommunication service plans includes presenting a tabulation of the preference indicators to features of the at least one of the alternative telecommunication service plans.

9. The method of claim 5, wherein rating at least one of the alternative telecommunication service plans is in further response to a cost of the at least one of the alternative telecommunication service plans.

10. The method of claim 5, wherein rating at least one of the alternative telecommunication service plans is in further response to a quality of service rating of the at least one of the alternative telecommunication service plans.

11. The method of claim 5, wherein rating at least one of the alternative telecommunication service plans is in further response to a recommended rating of the at least one of the alternative telecommunication service plans.

12. The method of claim 5, wherein rating at least one of the alternative telecommunication service plans is in further response to an award associated with the at least one of the alternative telecommunication service plans.

13. The method of claim 5, wherein rating at least one of the alternative telecommunication service plans is in further response to a preferred relationship associated with the at least one of the alternative telecommunication service plans.

14. The method of claim 5, wherein receiving the preference indicators further comprises receiving ranked preference indicators.

15. The method of claim 5, wherein receiving the preference indicators further comprises receiving weighted preference indicators.

16. The method of claim 5, wherein receiving the preference indicators further comprises receiving mandatory requirements.

17. A system for rating alternative telecommunication service plans, the system comprising:
a network interface operable to receive data from a network, the data including preference indicators associated with a user;
a database operable to store parameters of the alternative telecommunication service plans; and
a processor in communication with the network interface and the database, the processor operable to compare the preference indicators to at least one of the parameters for at least one of the alternative telecommunication service plans and rate the at least one of the alternative telecommunication service plans in response to the comparison.

18. The system of claim 17, and further comprising a rules-based software engine stored in a memory, the processor operable to use the rules-based software engine to rate the at least one of the alternative telecommunication service plans in response to the comparison.

19. The system of claim 17, and further comprising fuzzy logic stored in a memory, the processor operable to use the fuzzy logic to rate the at least one of the alternative telecommunication service plans in response to the comparison.

20. The system of claim 17, and further comprising an iterative algorithm stored in a memory, the processor operable to use the iterative algorithm to rate the at least one of the alternative telecommunication service plans in response to the comparison.

21. The system of claim 17, and further comprising a second database operable to store prior use data associated with the user.

22. The system of claim 17, and further comprising a second database operable to store information about employees of an enterprise.

23. The system of claim 22, wherein the second database includes a prior use record for each of the employees.

24. The system of claim 22, wherein the second database is operable to store a threshold associated with one or more of the employees, the threshold designating an amount of use associated with generating a notification.

25. The system of claim 17, and further comprising a second database operable to store a threshold associated with one or more of the alternative telecommunication service plans, the threshold designating an amount of prior use data associated with offering a user or an enterprise a discounted price.

26. A method of rating alternative service plans, the method comprising:
receiving prior use data associated with a user;
comparing the alternative service plans to the prior use data; and
rating at least one of the alternative service plans in response to the comparison.

27. The method of claim 26, and further comprising:
determining a cost associated with the user in response to receiving the prior use data; and
generating a notification if the determined cost exceeds a predetermined threshold.

28. The method of claim 26, and further comprising:
receiving a request for a new product or service associated with the user; and
generating a notification in response to receiving the request.

29. The method of claim 28, and further comprising:
receiving an approval in response to the notification; and
initiating a purchase in response to the approval.

30. The method of claim 26, and further comprising:
updating a database of an enterprise in response to receiving the prior use data; and
comparing the prior use data to historical data stored in the database.

31. The method of claim 26, wherein comparing the prior use data includes comparing the prior use data to additional use data of other users.

32. The method of claim 26, wherein receiving prior use data includes the number of minutes used of a service during receiving a present month and further comprising:
comparing the received number of minutes to a threshold number of minutes; and
generating a notification in response to the comparison.

33. The method of claim 32, wherein generating a notification includes generating a notification that the threshold number of minutes available in a current service plan have been exceeded.

34. The method of claim 32, wherein generating a notification includes generating a notification that at least one of the alternative service plans is available that would reduce the cost of the service.

35. The method of claim 26, wherein rating at least one of the alternative service plans comprises determining a cost of the at least one of the alternative service plans during at least one historical billing period in response to the received prior use data.

36. The method of claim 26, and further comprising:
receiving hypothetical use data; and
wherein rating at least one of the alternative telecommunication service plans comprises determining a cost of the at least one of the alternative service plans during at least one future billing period using the hypothetical use data.

37. The method of claim 26, wherein rating at least one of the alternative service plans comprises determining a cost of the at least one of the alternative service plans during at least one future billing period using hypothetical use data derived from the prior use data.

38. The method of claim 26, and further comprising discounting a cost of at least one of the alternative service plans in response to receiving the prior use data.

39. The method of claim 26, and further comprising:
further comparing the prior use data to at least one threshold; and
discounting a cost of at least one of the alternative service plans in response to the further comparison.

40. The method of claim 26, and further comprising:
receiving additional prior use data associated with additional users; and
discounting a cost of at least one of the alternative service plans in response to receiving the additional prior use data and the number of additional users.

41. A method of rating alternative data and voice communications service plans using a computer, the method comprising:
receiving preference indicators associated with one or more users;
comparing the alternative data and voice communication service plans to the preference indicators; and
rating at least one of the alternative data and voice communication service plans in response to the comparison.

42. The method of claim 41, wherein comparing the alternative data and voice communication service plans further comprises comparing a first combination of a first data communications service plan offered by a first vendor and a first voice communications service plan offered by the first vendor to a second combination of a second data communications service plan offered by a second vendor and a second voice communications service plan offered by a third vendor.

43. The method of claim 41, wherein receiving preference indicators includes receiving first preference indicators associated with a service plan and second preference indicators associated with a communications device.

44. The method of claim 43, wherein comparing the alternative data and voice communication service plans further comprises comparing the second preference indicators to features of a communications device available under at least one of the alternative data and voice communication service plans.

45. A method of rating alternative service plans using a computer, the method comprising comparing mandatory requirements, desired optional service features, and prior use data to parameters of the alternative service plans and rating the alternative service plans in response to the comparison.
